(19) United States
(12) Patent Application Publication
(10) Pub. No.: US 2001/0021640 A1
(43) Pub. Date: Sep. 13, 2001

(54) Motor vehicle wireless telephone system

(76) Inventor: Dirk Lappe, Karlsruhe (DE)

Correspondence Address: Patrick J. O'Shea, Esq., Samuels, Gauthier & Stevens LLP, Suite 3300, 225 Franklin Street, Boston, MA, 02110, US

(21) Appl. No.: 09/790,326

(22) Filed: Feb. 21, 2001

(30) Foreign Application Priority Data
Feb. 21, 2000 (DE) 100 07 806.0

(51) Int. Cl. H04B 5/00

(52) U.S. Cl. 455/41; 455/420; 455/517; 455/558; 455/575; 455/345

(57) ABSTRACT

To make it easier for a subscriber to operate a wireless phone and a transceiver in a vehicle, the transceiver transmits an identification to the wireless phone within a limited transmission and reception range. When the wireless phone receives this identification, it transmits its identification data to the transceiver to inscribe itself in the transceiver. Alternatively, the wireless phone transmits its identification data within a limited transmission and reception range, and the transceiver receives this identification data and that the wireless phone is inscribed (i.e., registered) with the transceiver. The transceiver acts as interface for calls to and from the wireless phone.

### BACKGROUND OF THE INVENTION

The present invention relates to the field of wireless telephone systems, and in particular to a wireless telephone system for a motor vehicle.

Numerous motor vehicles are equipped with transceivers that communicate over a wireless communication channel, for example in accordance with the Global Standard for Mobile Communication (GSM). In addition to the GSM broadcast network, there are many other known broadcast networks for wireless telephones. A problem with existing wireless telephones for motor vehicles is that the user often requires a first cellular telephone having a transceiver that is hard mounted in the motor vehicle, and a second cellular telephone having its own transceiver for use when the user is not in the motor vehicle.

Therefore, there is a need for a wireless telephone system for a motor vehicle that allows a user to utilize the transceiver mounted in the motor vehicle, even while the user is outside and at a distance from the motor vehicle.

### SUMMARY OF THE INVENTION

Briefly, according to a first aspect of the present invention, a transceiver for a motor vehicle transmits transceiver identification data to a wireless phone located within a limited transmission and reception range from the transceiver, and when the wireless phone receives the transceiver identification data it transmits its telephone identification data to the transceiver to inscribe itself with the transceiver.

According to a second aspect of the present invention, a wireless phone transmits its telephone identification data within a limited transmission and reception range to a transceiver installed in the vehicle, wherein the transceiver receives the telephone identification data and the wireless phone is inscribed in the transceiver.

If the wireless phone is situated within the limited range for transmission of identifying data, either the wireless phone sends its identifying data to the transceiver, or the transceiver sends its identification to the wireless phone. When the wireless phone receives the identification transmitted by the transceiver, the wireless phone transmits its identifying data to the transceiver. With both of the inventive methods, the wireless telephone is inscribed in the transceiver of the vehicle.

When the subscriber wishes to make a telephone call with his wireless phone, within its range from the transceiver, a wireless connection from the wireless phone is established to the associated transceiver in the vehicle. The transceiver establishes a radio connection to the associated mobile network. Similarly, if the subscriber receives a call on his wireless phone, the mobile network establishes a radio connection to the transceiver and the transceiver forwards the call to the wireless phone. Both for incoming and outgoing calls, the wireless telephone represents the handset of the transceiver in the vehicle.

In one embodiment, the telephone data bases of the wireless phone and of the transceiver are coordinated.

In a preferred embodiment, the identifying data of the wireless phone are transmitted and received in accordance with the Blue Tooth Standard at the carrier frequency of 2.4 GHz. The transceiver may to operate in accordance with the Global Standard for Mobile Communication, or any other known cellular phone service.

The wireless phone and the transceiver may include a subscriber identify module (SIM) reader that receives a SIM card (aka “a smartcard”) to provide subscriber identification. The transceiver or the wireless phone with the SIM card inserted is now defined as a unit of the SIM card holder, and calls to this subscriber are routed to this unit. Similarly, the subscriber whose SIM card is inserted is charged for the outgoing calls.

The transceiver may be connected to a ring-shaped data bus (B), to which data sources, data sinks, and a control unit are connected. The control unit controls the transceiver.

These and other objects, features and advantages of the present invention will become more apparent in light of the following detailed description of preferred embodiments thereof, as illustrated in the accompanying drawings.

### BRIEF DESCRIPTION OF THE DRAWING

FIG. 1 is a pictorial illustration of a subscriber having a wireless telephone, and a vehicle equipped with a transceiver for communication with a radio network over a wireless communication channel in accordance with the present invention; and

FIG. 2 illustrates a ring-shaped data bus with data sources, data sinks, a control unit, and a transceiver.

### DETAILED DESCRIPTION OF THE INVENTION

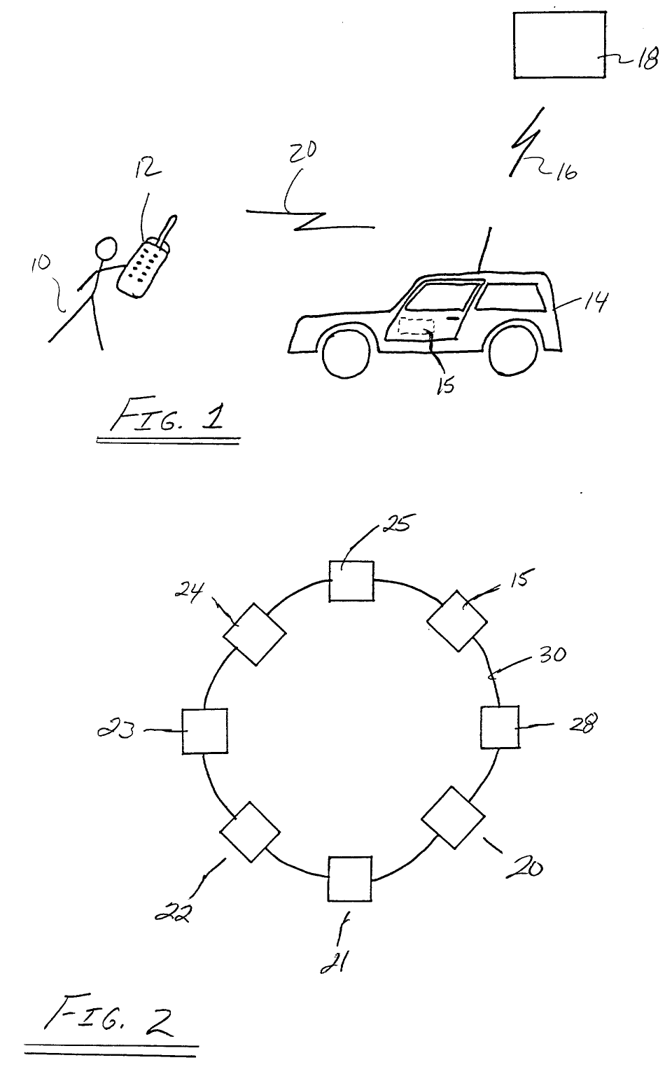

FIG. 1 is a pictorial illustration of a subscriber 10 having a wireless telephone 12, and a vehicle 14 equipped with a transceiver 15 for communication with a radio network 16 over a wireless communication channel 18. The wireless telephone 12 is located within a limited transmission and reception range from the transceiver 15, and the wireless telephone 12 and the transceiver preferably communicate over a wireless a Blue Tooth compatible communication channel 20.

In one embodiment, the transceiver 15 transmits a transceiver identification data to the wireless telephone 12, and in response the wireless phone receives the identification and transmits its wireless phone identification data to the transceiver to inscribe itself in the transceiver. Since the communication channel between the wireless telephone and the transceiver is preferably a communication protocol such as Blue Tooth, the channel may have a limited transmission and reception range.

In a second embodiment, the wireless telephone transmits its identification data to the transceiver to register (i.e., inscribe) the wireless phone with the transceiver.

The radio connections to and from the wireless phone 12 are not established directly between the wireless phone and the associated radio network 18, but rather the transceiver 15 acts as an interface. Consequently, a radio connection is established between the transceiver 15 and the wireless phone 12. A radio connection is also established between the transceiver 15 and the associated radio network 18. Consequently the subscriber can call any arbitrary subscriber with his wireless phone with the transceiver acting as an interface. In the reverse direction, any arbitrary subscriber can call the subscriber's wireless telephone with the transceiver acting as interface.

FIG. 2 is a block diagram illustration of a communication system installed in a vehicle. A plurality of data sources and data sinks 20-25, the transceiver 15, and a control unit 28 are connected to a ring-shaped data bus 30. The data sources and data sinks 20-25 may include for example radio receivers, television receivers, cassette recorders, CD players, DVD players, and reproduction units such as for example displays and/or loudspeakers. The control unit 28 controls the devices connected to the ring-shaped data bus 30, including the transceiver 15.

The wireless phone can be used as the handset of the transceiver 15 in the vehicle, and thus no additional wireless or wire-bound earpiece or handset is required. Another advantage is that the SIM card of the wireless phone and the transceiver can be coordinated.

Although the present invention has been shown and described with respect to several preferred embodiments thereof, various changes, omissions and additions to the form and detail thereof, may be made therein, without departing from the spirit and scope of the invention.

What is claimed is:

1. A method for operating a transceiver installed in a motor vehicle that communicates with a wireless phone and a communication network, said method comprising:
transmitting transceiver identification data to the wireless phone that is located within a limited transmission and reception range with respect to the transceiver; and
receiving telephone identification data that is transmitted by the wireless telephone in response to receiving said transceiver identification data and inscribing the wireless telephone with the transceiver in response to receiving said telephone identification data.

2. A method for operating a transceiver installed in a motor vehicle that communicates with a wireless phone and a communication network, said method comprising receiving telephone identification data from the wireless phone within a limited transmission and reception range of the transceiver and inscribing the wireless telephone with the transceiver in response to receiving said telephone identification data.

3. A method of claim 1, wherein said telephone identification data is transmitted by said wireless telephone based upon called Blue Tooth Standard technology at a carrier frequency of 2.4 GHz.

4. The method of claim 3, further comprising transmitting data between the transceiver and the communication network using a GSM compatible communication protocol.

5. A transceiver unit for a motor vehicle that communicates via a first wireless communication channel with a wireless telephone and communicates via a second wireless communication channel with a cellular telephone communication network, said transceiver comprising:
means for transmitting transceiver identification data over the first communication channel to the wireless phone;
means for receiving telephone identification data from the wireless phone over the first communication channel;
a cellular telephone transceiver that transmits and receives data over the second wireless communication channel.

6. The transceiver unit of claim 5, wherein said means for receiving telephone identification data includes means for receiving the telephone identification data that is encoded in accordance with the Blue Tooth Standard at a carrier frequency of 2.4 GHz.

7. The transceiver unit of claim 5, wherein said means for transmitting transceiver identification data includes means for transmitting the transceiver identification data encoded in accordance with the Blue Tooth Standard at a carrier frequency of 2.4 GHz.

8. The transceiver unit of claim 5 wherein
said means for receiving telephone identification data includes means for receiving the telephone identification data that is encoded in accordance with the Blue Tooth Standard at a carrier frequency of 2.4 GHz; and
said means for transmitting transceiver identification data includes means for transmitting the transceiver identification data encoded in accordance with the Blue Tooth Standard at a carrier frequency of 2.4 GHz.

9. The transceiver unit of claim 8, wherein said cellular telephone transceiver comprises a GSM transceiver.

10. The transceiver unit of claim 8, wherein said cellular telephone transceiver comprises a SIM card reader configured and arranged to receive a SIM card.

11. The transceiver unit of claim 8, wherein said wireless telephone comprises a SIM card reader configured and arranged to receive a SIM card.
